(19) United States
(12) Patent Application Publication
(10) Pub. No.: US 2025/0278058 A1
(43) Pub. Date: Sep. 4, 2025

(54) HOLOGRAPHIC SYSTEM WITH IMPROVED PROJECTION QUALITY

(71) Applicant: SYDDANSK UNIVERSITET, Odense M (DK)

(72) Inventor: Jesper GLÜCKSTAD, Odense M (DK)

(21) Appl. No.: 18/859,654

(22) PCT Filed: Apr. 24, 2023
(86) PCT No.: PCT/EP2023/060648

§ 371 Date: Oct. 24, 2024

(30) Foreign Application Priority Data
Apr. 25, 2022 (EP) 22169752.7

(51) Int. Cl. G03H 1/30

(52) U.S. Cl. CPC G03H 1/30; G03H 2001/306

(57) ABSTRACT

The invention relates to a method for generating a pixelated projection in a reconstruction space. The method includes determination of a first discretized hologram, wherein the first discretized hologram is determined to generate a desired amplitude profile of an output pixel in the reconstruction space; determination of a second discretized hologram having a phase distribution determined to create a desired projection in the reconstruction space; determination of a tiled hologram by tiling the second discretized hologram a number of one or more times in one or two directions, wherein the number of tilings and the first discretized hologram are determined subject to an output pixel constraint determined based on a dimension of the amplitude profile of the output pixel in the reconstruction space and a pixel pitch in the reconstruction space. A composite hologram is determined based on a phasor multiplication of the first discretized hologram and the tiled hologram. A coherent input beam is phase modulated based on the composite hologram so that the phase modulated beam generates the pixelated projection in the reconstruction space. A particular application of the invention is the use for volumetric additive manufacturing (VAM), especially for medical use, such as implants.

### FIELD OF THE INVENTION

The invention relates to computer generated holography, particularly to methods for reducing speckle generation in computer generated holography.

### BACKGROUND OF THE INVENTION

WO2015/165471 A1 discloses a method for providing an intensity pattern, such as an image, more particularly a contiguous intensity pattern with reduced speckle. The method comprises encoding a spatial light modulator with a modulation pattern so as to form the intensity pattern as a diffraction pattern, where the method furthermore comprises shaping an input beam so that the point spread function in the output region where the diffraction pattern is formed has suppressed side lobes, such as the point spread function being substantially rectangular in shape, and wherein the method furthermore comprises tiling the modulation pattern so that the spacing between the individual point spread function corresponds to their widths. An effect of this may be that the output pattern is formed as a pattern of closely spaced point spread functions, which enables forming a contiguous pattern with reduced speckle.

Whereas WO2015/165471 A1 presents a method addressing the problem with speckle, the present invention has been devised with an aim of further reducing image speckle and improving the holographic system.

### SUMMARY OF THE INVENTION

It is an object of the invention to provide an improved method for computer generated holography, particularly an improvement that addresses the problem with speckles but also provides other improvements.

In a first aspect of the invention, a method for generating a pixelated projection in a reconstruction space is presented. The method comprises
determining a first discretized hologram having a phase distribution in a plane, wherein the first discretized hologram is determined to generate a desired amplitude profile of an output pixel in the reconstruction space,
determining a second discretized hologram having a phase distribution determined to create a desired projection in the reconstruction space,
determining a tiled hologram by tiling the second discretized hologram a number of one or more times in one or two directions, wherein the number of tilings and the first discretized hologram are determined subject to an output pixel constraint determined based on a dimension, e.g. ΔXpsf and/or ΔYpsf, of the amplitude profile of the output pixel in the reconstruction space and a pixel pitch, e.g. ΔXholo and/or ΔYholo in the reconstruction space,
generating or determining a composite hologram based on a phasor multiplication of the first discretized hologram and the tiled hologram, and
phase modulating a coherent input beam based on the composite hologram and directing the phase modulated beam towards the reconstruction space to generate the pixelated projection in the reconstruction space.

Advantageously, the first discretized hologram is responsible for generating a specific amplitude profile of an output pixel. Since the first discretized hologram is implemented on a spatial light modulator, alternatively a fixed phase mask, additional beam shaping optics is not required for shaping the input beam to generate a desired amplitude profile at the reconstruction space.

Furthermore, the output pixel amplitude profile can be adapted by modifying the first discretized hologram.

Advantageously, the combination of the first and second discretized hologram into a composite hologram through the phasor multiplication provides a simple and cost effective implementation of the computer generated hologram.

The size of the amplitude profile of the output pixel refers to a dimension of the amplitude profile in the reconstruction space. The dimension therefore represents the output pixel size.

The tiling refers to a process wherein the second discretized hologram is distributed over the area of a Spatial Light Modulator (SLM) or a fixed phase mask by copying the second discretized hologram so that at least two identical second discretized holograms are placed adjacent to each other along a side of the holograms. At least two second discretized holograms are adjacently placed along at least one direction in the plane (which may be flat or curved) of the SLM or the fixed phase mask. For example, the second discretized holograms may be repeated and adjacently placed along perpendicular directions in the plane of the SLM or fixed phase mask.

Herein a multiplication, i.e. a phasor multiplication, is an element-by-element multiplication where the elements z_i,j in a matrix or vector Z of the multiplication result is given by multiplications of elements x_i,j and y_i,j in respective matrices or vectors X and Y, i.e. z_i,j=x_i,j·y_i,j, for i∈1 . . . m and j∈1 . . . n. In this example X represents the first discretized hologram, Y represents the tiled hologram and Z represents the composite hologram. Each of the matrices/vectors X, Y and Z have equal dimensions.

The steps of determining the first and second discretized holograms may be performed in a computer. Subsequently, the first and second holograms may be used for controlling one or two spatial light modulators (SLM), wherein the first hologram may be used directly and the second hologram may be tiled. With use of one SLM, the SLM implements a computer determined phasor multiplication of the first discretized hologram and the tiled hologram.

Alternatively, anyone of the determined first and second discretized holograms, or both, may be used subsequently for generating a fixed phase mask implementing the determined holograms or tiled versions thereof.

The tiled hologram may be determined in a computer by tiling the second discretized hologram.

Alternatively, the tiled hologram may be generated by an optical tiling system arranged to tile the phase distribution generated based on the second discretized hologram by an SLM or a fixed phase mask. A combination where the optical tiling system optically generates a further tiling of a tiled phase distribution generated by an SLM is also feasible. Thus, an SLM or a fixed phase mask may generate the phase distribution of a single second discretized hologram or tiled, e.g. a 4×4 tiled, second discretized hologram and the optical tiling system may generate a further tiling of said phase distribution.

The multiplication of the first discretized hologram and the tiled hologram may be determined in a computer and subsequently used for controlling an SLM.

It is understood that the phasor multiplication may alternatively by the result of input light being transmitted through adjacently placed first and second phase modifying devices, where each of the first and second phase modifying devices may be embodied by a fixed phase mask or an SLM. Clearly, the transmission through two adjacent first and second phase modifying devices generates a cumulative change of the optical phases pixel-by-pixel equivalent to the phasor multiplication of two holograms where the phasor multiplication results in pixel-by-pixel additions of the pixel phases of the two holograms, e.g. phasor multiplication of the first discretized hologram and the tiled hologram.

According to an embodiment, the pixel constraint requires that the dimension ΔXpsf is smaller than, equal or substantially equal to the pixel pitch ΔXholo. By choosing ΔXpsf to be equal to or slightly less than ΔXholo, in practice it may occur that ΔXpsf becomes larger than ΔXholo, e.g. for a fraction of the output pixels, e.g. by a minor percentage such as 1 percent. The same applies to the width ΔYpsf and pixel pitch ΔYholo in the perpendicular second direction that may be equal to or different from the width and separation in the first direction. Thus, the x and y directions may be optimized independently of each other and the pixel constraints may be satisfied by different pixel and pitch values in each direction. Clearly, the output pixels may be arranged according to other coordinate systems than Cartesian systems, and may therefore also be arranged in polar-, cylindrical- and spherical coordinate systems.

According to an embodiment, the determination of the tiled hologram comprises determination of a tiling number, e.g. NT or NT1 and NT2 in two directions, of the tiled hologram subject to the pixel constraint and the dimension, e.g. ΔXpsf and/or ΔYpsf, of the amplitude profile of the output pixel. Thus, the method may comprise determining tiling numbers NT, NT1, NT2 dependent on the dimension ΔXpsf and/or ΔYpsf of the output pixel so that the output pixel constraint is satisfied. Advantageously, when the dimension such as ΔXpsf, ΔYpsf is predetermined, the output pixel constraint may be satisfied by determining the tiled hologram, particularly the tiling numbers.

According to an embodiment, the determination of the first discretized hologram comprises determination of the dimension such as ΔXpsf and/or ΔYpsf of the amplitude profile of the output pixel subject to the pixel constraint and a tiling number (NT, NT1, NT2) of the tiled hologram. Thus, the method may comprise determining ΔXpsf and/or ΔYpsf dependent on the tiling numbers NT, NT1, NT2 so that the output pixel constraint is satisfied. Advantageously, when the tiling numbers are predetermined, the output pixel constraint may be satisfied by determining lateral pixel size ΔXpsf, ΔYpsf subject to the constraint.

According to an embodiment, the first discretized hologram is determined dependent on a desired dimension ΔXpsf, ΔYpsf of the amplitude profile of the output pixel.

For example, the first discretized hologram may be determined so that at least 70% of a total power of the amplitude profile in the reconstruction space is contained within the pixel, i.e. within the output pixel lateral dimensions ΔXpsf, ΔYpsf. For example, the first discretized hologram may be determined so that the percentage of the total power of the amplitude profile in the reconstruction space is contained within the pixel is at least 50%, such as 60% or 70%, for example a percentage within the range from 50%-99%, such as within 60%-90%.

According to an embodiment, the determination of the second discretized hologram comprises determining the phase distribution so that at least some of the output pixels of the desired projection are determined to be reconstructed in different positions along a propagation direction of the input beam in the reconstruction space. Advantageously, the second discretized hologram and thereby the tiled hologram may be determined so the position along the propagation direction where the output pixels are generated, i.e. are reconstructed with sharply delimited pixel edges, are different for different pixels, e.g. for the purpose of generating the projection on a curved surface or in a 3D space.

According to an embodiment, the phase modulation comprises controlling a spatial light modulator to generate a discretized phase distribution corresponding to the first discretized hologram, the tiled hologram or the composite hologram. Advantageously, the spatial light modulator may be combined with a fixed phase mask, e.g. so that first discretized hologram is implemented in the fixed phase mask while the tiled hologram is implemented in the spatial light modulator.

A second aspect of the invention relates to a holographic system arranged for generating a pixelated projection in a reconstruction space, wherein the holographic system comprises a
a data processor arranged to perform the steps of the first aspect,
a light source for generating the coherent input beam,
a spatial light modulator arranged for phase modulating the coherent input beam based on the composite hologram and directing the phase modulated beam towards the reconstruction space to generate the pixelated projection in the reconstruction space.

A third aspect of the invention relates to a holographic system arranged for generating a pixelated projection in a reconstruction space according to the first aspect, wherein the holographic system comprises a
a first fixed phase mask configured with a discretized phase distribution according to the first discretized hologram and a spatial light modulator arranged for generating a phase modulation according to the tiled hologram, or
a spatial light modulator arranged for generating a phase modulation according to the first discretized hologram and a second fixed phase mask configured with a discretized phase distribution according to the tiled hologram, or
a first fixed phase mask configured with a discretized phase distribution according to the first discretized hologram and a second fixed phase mask configured with a discretized phase distribution according to the tiled hologram, or
a first fixed phase mask configured with a discretized phase distribution according to the composite hologram, and
a light source for generating the coherent input beam and arranged to transmit light through the discretized phase distributions generated at least by the first fixed phase mask and/or the second fixed phase mask, and for directing the phase modulated beam towards the reconstruction space to generate the pixelated projection in the reconstruction space.

Advantageously, one of the discretized holograms may be implemented in a fixed phase mask. Particularly, the implementation of the composite hologram in a fixed phase mask may enable ultra-high resolution due to the higher available pixel density in fixed phase masks as compared with controllable spatial light modulators.

In the third aspect it is understood that the holographic system may also include a data processor arranged to perform the relevant steps of the first aspect, i.e. the steps of determining the first discretized hologram, the second discretized hologram, the tiled hologram and/or the composite hologram and the for controlling the spatial light modulator when present in the system.

According to an embodiment the spatial light modulator arrangement comprises a spatial light modulator and an optical tiling system, wherein the spatial light modulator is arranged to generate the second discretized hologram, alternatively the tiled hologram, and the optical tiling system is arranged to tile the second discretized hologram, alternatively the optical tiling system is arranged to further tile the tiled hologram.

According to an embodiment the optical tiling system comprises an imaging system, such as a lens array or a mirror scanner, configured to generate the tiling and to project incident light into the reconstruction space.

The paper “Direct fabrication of seamless roller molds with gapless and shaped-controlled concave microlens arrays, Guangqing Du et al. OPTICS LETTERS Vol. 37, No. 21 Nov. 1, 2012 provides an example of optical tiling by use of a lens array.

A fourth aspect of the invention relates to a computer program comprising instructions to cause the data processor of the second aspect to execute the steps of the first aspects.

A fifth aspect of the invention relates to the use of the method according to first aspect or the system of the second or the third aspect for any one of the following:
multiphoton optical excitation of biologic cells,
printing 3D objects,
holographic displaying,
photopolymerization, such as two-photon photopolymerization,
laser material processing, such as one shot material processing,
photolithography,
structured illumination microscopy,
treatment of skin, such as cosmetic treatment of skin,
in conjunction with temporal focusing of an ultrafast pulsed laser for multiphoton excitation in selected depth layers,
ultrafast additive manufacturing,
laser material processing in parallel,
rapid laser engraving, welding, machining
two-photon excitation in optogenetics and voltage imaging
multi-color and multi-plane diffraction
photon-efficient phase-only display technology
real-time adaptive optics embodiments including aberration correction, and
temporal focusing (TF).

The temporal focusing may be achieved by using a fixed grating.

Advantageously, the invention further relates to use of the method according to the first aspect, or the system according to the second aspect, for printing 3D objects using volumetric additive manufacturing (VAM), preferably for printing 3D objects for medical use, preferably biocompatible implants, synthetic organs, or parts thereof, or similar objects.

In general, the various aspects and embodiments of the invention may be combined and coupled in any way possible within the scope of the invention. These and other aspects, features and/or advantages of the invention will be apparent from and elucidated with reference to the embodiments described hereinafter.

### BRIEF DESCRIPTION OF THE DRAWINGS

Embodiments of the invention will be described, by way of example only, with reference to the drawings, in which

FIG. 1A shows point spread functions in the reconstruction space and the side lopes of the point spread functions that lead to an undesired speckle pattern,

FIG. 1B shows improved point spread functions that lead to reduced speckle,

FIG. 2A shows a holographic system arranged for generating a pixelated reconstruction image projection at the reconstruction space based on an improved hologram determination method,

FIG. 2B shows an alternative holographic system arranged for generating a pixelated reconstruction image projection in the reconstruction space based where the system includes one or two fixed phase arrays, e.g. one fixed phase array in combination with one SLM,

FIG. 3A illustrates method steps of an embodiment,

FIG. 3B illustrates the method for determining a composite hologram through phasor multiplication of a PSF shaping hologram and a tiled object hologram where the latter is determined by tiling an object hologram which is determined based on a desired projection image, here a two-dimensional image of the letter H,

FIG. 4 shows output pixels in a pixel row of the pixelated reconstruction image the pixel pitch ΔXholo and pixel width ΔXpsf, and

FIG. 5 shows a Gerchberg-Saxton algorithm for determining the PSF shaping hologram,

FIG. 6A shows examples of the first discretized hologram 311 and the tiled hologram 313,

FIG. 6B shows an example of the pixelated projection 201 and the pixelated image forming, and

FIGS. 7-10 show embodiments within the area of volumetric additive manufacturing (VAM), where the present invention may be applied.

### DETAILED DESCRIPTION

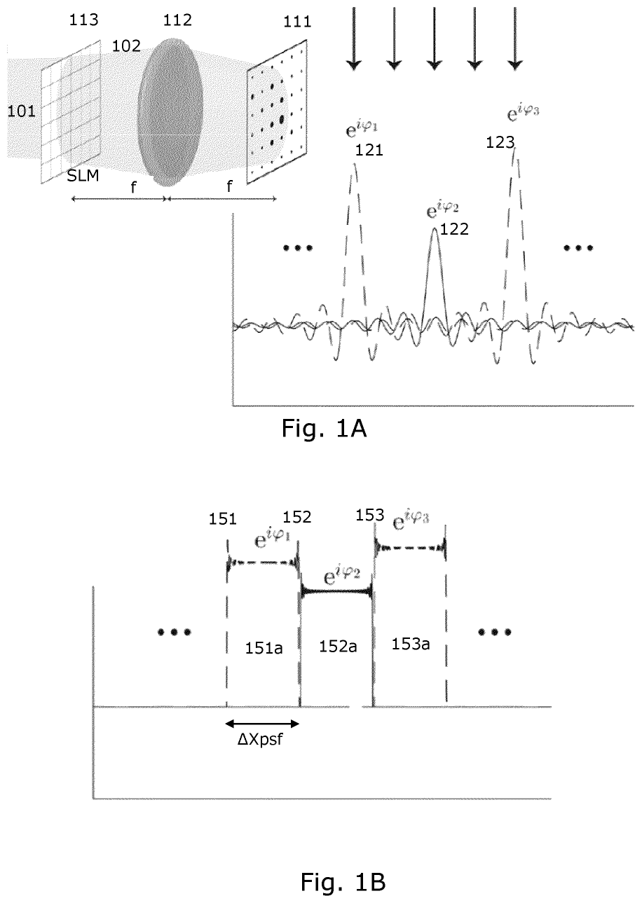

FIG. 1A illustrates the generation of an image projection based on a computer generated hologram. The computer generated hologram comprises a discretized phase distribution σ(x,y) as a function of coordinates x,y in a plane. The phase distribution is determined according to known methods. For example, the phase distribution may be determined based on an image so that the same image can be reconstructed based on the phase distribution. In general the image generated from the phase distribution σ(x,y) is referred to as a reconstructed image. A spatial light modulator SLM is controlled according to the discretized phase distribution. Specifically, the spatial light modulator SLM comprises a matrix of addressable optical elements, where each element is capable of changing the phase of the portion of an input light beam 101 that interacts with that element. Each element can be controlled to generate a desired phase change and therefore the spatial light modulator can be controlled to generate the phase distribution σ(x,y) of the computer generated hologram. The discretized phase distribution of the computer hologram may be represented as a matrix of phase values, wherein the matrices of the phase distribution and the SLM element may have the same dimensions, although they may also have different dimensions.

The spatial light modulator may be transmission based as illustrated in FIG. 1A or reflection based.

The input beam 101 is a coherent beam such as a laser beam. The degree of spatial and temporal coherence of the input beam may depend on the application. Thus, a temporally semi-coherent beam from a spatially coherent LED, a super-luminescent diode or a semi-coherent laser source may be sufficient. The input beam 101 may also originate from a pulsed light source, such as a femto-second laser. The pulsed laser may be used in connection with multiphoton excitation.

The phase modulation of the input beam can be used with any polarization state of the input beam including circular polarization states of the input light.

The spatial light modulator generates a phase modulated light beam 102 which forms an image projection at the reconstruction space 111 due to diffraction effects. That is, the interference of the phase modulated beam at the reconstruction space results in an intensity distribution at the reconstruction space corresponding to an image such as a desired projection, e.g. a desired image, or a desired intensity distribution from which the phase distribution of the computer generated hologram is determined.

A lens 112 may be used so that the diffraction image is generated at the focal reconstruction space 111 of the lens. However, lens-free solutions may also be used where the image is generated without the use of the Fourier lens 112. Lens-free solutions are usually referred to as Fresnel or Fraunhofer holography.

FIG. 1A illustrate individual amplitude curves 121-123, also referred to as point spread functions (PSF), of the reconstruction image in the reconstruction space 111. The individual amplitude curves 121-123 have different phases □1-□3. The reconstructed image results from the interference of the individual amplitude curves 121-123, i.e. the superposition of the individual amplitude curves 121-123 taking into account the individual phases □1-□3.

The main peaks of the amplitude curves 121-123 can be considered as output pixels of the image projection, where the light amplitude of each output pixel can be controlled according to the phase distribution σ(x,y) of the computer generated hologram.

Interference of the side lobes of the amplitude curves 121-123 results in speckle around the main peaks and therefore reduces the quality of the diffraction image.

Using a spatial light modulator operating in phase-only mode for maximal light efficiency, speckles are impossible to avoid in reconstructed intensities when many pixels at the SLM are mapped to individual pixel spots at the output. Due to diffraction effects from the finite aperture of the SLM or the expanded coherent light beam reading out the SLM, it is impossible to avoid nearest neighbor pixel spot cross-talk at the reconstruction space 111 and thereby speckle due to the fluctuating phase at the reconstruction space 111 when solely controlling the output amplitude values.

Each output light spot 121-123 or output pixel in the output light pattern is generated as a result of a global transform of the input phase distribution σ(x,y) generated by the spatial light modulator SLM, i.e. as generated by the SLM in a discretized form. However, by constraining the SLM phase distribution σ(x,y) to generate a desired output intensity pattern one inherently loses control over the particular phase values of each output pixel 121-123. The resulting fluctuating output phase leads to a fluctuating interference between nearest neighbour output pixels due to light spill over from the tails of the point spread function (PSF) governed by the truncating apertures of the overall optical system.

FIG. 1B shows the individual amplitude curves 151-153 of a diffraction image in the reconstruction space 111 generated according to a solution of an embodiment of the invention. FIG. 1B shows that the side lobes have been reduced, but at the cost of a less narrow amplitude peak. Due to the suppression of the side lobes, the speckle is reduced and the image quality improved. Each peak of the individual amplitude curves 151-153 represents an image output pixel 151a-153a. The amplitude curves 151-153 are equivalent to the point spread functions 121-123, but shaped to approximate flattop square point spread functions 151-153.

The phase distribution of the computer generated hologram is determined so that each of the individual amplitude curves 151-153 and thereby the amplitude of each output pixel 151a-153a is generated by a group of one or more addressable elements of the spatial light modulator SLM. Accordingly, the amplitude of each output pixel 151a-153a can be controlled by adjusting the phase distribution of the computer generated hologram.

The phase distribution determined to generate the desired amplitude profile of an output pixel in the reconstruction space, such as a flattop square point spread function (PSF), can be determined in different ways. For example this phase distribution may be determined by use of the Gerchberg-Saxton algorithm for phase retrieval (cf. Gerchberg R W and Saxton W 0 1972 OPTIK 35 p. 237-246). In another example the phase distribution may be determined from an analytical approach. Both methods are described below.

The determined phase distribution is converted into a discretized hologram by discretizing the values of the determined phase distribution according to the pixel dimensions of the SLM, e.g. according to the pixel dimensions and pixel pitch of the SLM.

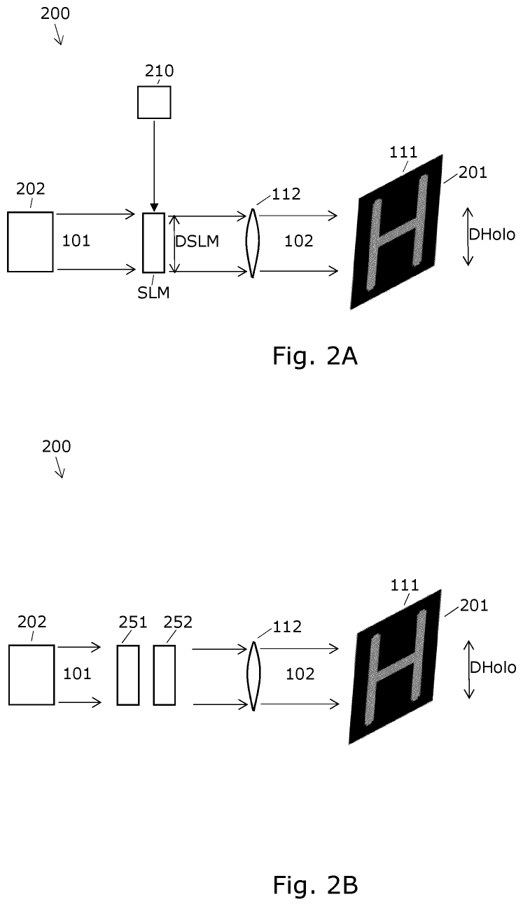

FIG. 2A illustrates a holographic system 200 arranged for generating the pixelated projection 201 in the reconstruction space 111.

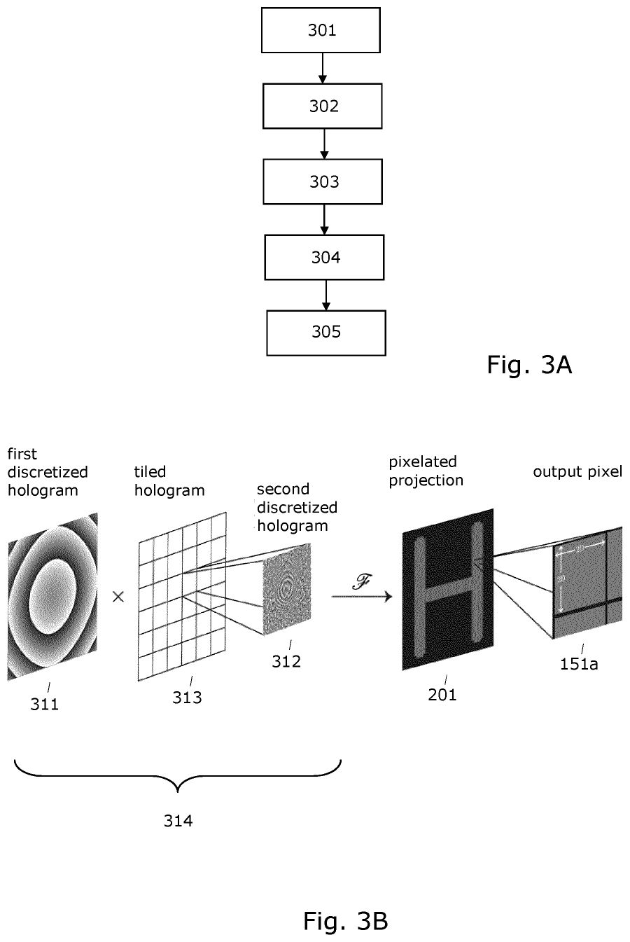

The holographic system comprises a data processor 210 such as a computer arranged to determine a composite hologram or a specific SLM controller. The determination of the composite hologram is described in connection with FIGS. 3A and 3B. The data processor 210 may be arranged to generate a single static composite hologram or a series of composite holograms in order to generate an image sequence at the reconstruction space 111.

The holographic system further comprises a light source 202 for generating the coherent input beam 101 and the spatial light modulator SLM arranged for phase modulating the coherent input beam based on the composite hologram. Optionally, the holographic system 200 comprises a Fourier lens 112. The output beam of the spatial light modulator SLM propagates, possibly via the Fourier lens 112, towards the reconstruction space 111 to generate the pixelated projection 201 at the reconstruction space 111. Alternatively, a lens-free Fresnel or Frauenhofer solution may be used.

The reconstruction space 111 may be a 2-dimensional image plane or a three-dimensional reconstruction space. In case the reconstruction space 111 is a three-dimensional reconstruction space, the second discretized hologram 313 may be determined based on a three-dimensional image.

An image herein is understood as any intensity distribution and need not be a visible image but also include any intensity distribution determined by a computer process, mathematically, or in other ways.

FIG. 2B shows an alternative configuration of the holographic system 200. The alternative holographic system comprises first and second phase modifying elements 251, 252. The first phase modifying element 251 may be embodied by the spatial light modulator SLM or a first fixed phase mask. Similarly, the second phase modifying element 252 may be embodied by the spatial light modulator SLM or a second fixed phase mask.

The fixed phase mask contains a matrix of individual fixed phase modifying pixel elements where the phase of each pixel element is set according to the determined first discretized hologram 311, the tiled hologram 313 or composite hologram 314. Examples of the fixed phase masks comprise Diffractive Optical Elements (DOEs), polymer based phase masks, refractive phase masks and meta-material based phase masks.

Relevant combinations of the embodiments of the first and second phase modifying elements 251, 252 comprises: a first embodiment wherein the first phase modifying element 251 is a first fixed phase mask and the second phase modifying element 252 is an SLM, a second embodiment wherein the first phase modifying element 251 is an SLM and the second phase modifying element 252 is a second fixed phase mask, a third embodiment wherein the first phase modifying element 251 is a first fixed phase mask and the second phase modifying element 252 is a second fixed phase mask, and a fourth embodiment wherein the first phase modifying element 251 is a first fixed phase mask and the second phase modifying element 252 may be omitted.

According to the first embodiment, the first fixed phase mask implements the determined first discretized hologram 311 and the SLM—controlled by the data processor 210 (not shown in FIG. 3B)—implements the tiled hologram 313 (cf. FIG. 3B).

According to the second embodiment, the second fixed phase mask implements the determined tiled hologram 313 and the SLM implements the first discretized hologram 311.

According to the third embodiment, the first fixed phase mask implements the first discretized hologram 311 and the second fixed phase mask implements the tiled hologram 313.

According to the fourth embodiment, the first fixed phase mask implements the determined multiplication of the first discretized hologram 311 with the tiled hologram 313, i.e. the first fixed phase mask embeds the composite hologram 314.

When illuminated by the input beam 101, the spatial phase distribution of light propagating through the first and second phase modifying elements 251, 252 is modified first by the first phase modifying element 251 and secondly by the second phase modifying element 252 so that the cumulative final phase modification of the first and second phase modifying elements 251, 252 corresponds to the determination of the composite hologram 314 based on a phasor multiplication of the first discretized hologram and the tiled hologram.

Accordingly, the first and second phase modifying elements 251, 252 generates a phase modulation of the coherent input beam 101 based on the cumulative effect of the phase modifying elements 251, 252 corresponding to the composite hologram 314 or corresponding to the phasor multiplication of the first discretized hologram and the tiled hologram.

It is noted that the spatial phase modulation of the input light can be done by a static or dynamic spatial light modulation such as described in “GPC-based optical micromanipulation in 3D real-time using a single spatial light modulator”, P. J. Rodrigo, I. R. Perch-Nielsen, C. A. Alonzo, J. Glückstad, Optics Express 14 (26), 13107-13112 (2006), and in “GPC light shaper: static and dynamic experimental demonstrations”, A. Bañas, O. Kopylov, M. Villangca, D. Palima, J. Glückstad, Optics Express 22 (20), 23759-23769 (2014), the contents of which is hereby incorporated by reference. In general, the spatial phase modulation can be performed by known Spatial Light Modulators including Liquid Crystal SLMs (LC-SLMs), Liquid Crystal on Silicon SLMs (LCoS-SLMs), Micro Electro-Mechanical Systems SLMs (MEMS-SLMs), Deformable Mirror SLMs (DM-SLMs), Digital Mirror Devices (DMDs), Acousto-Optic SLMs (AO-SLMs), or any other type of SLM. Moreover, spatial phase modulation does not necessarily involve spatially moving elements of the Spatial Light Modulator or Phase Mask. Rather a local property (such as transparency, refractive index or optical path length) of the elementary units or pixels can be modified. It is also possible to encode the required spatial phase modulation on an amplitude-only SLM by encoding the phase on a spatial amplitude carrier wave such as provided by synthetic interference fringes. The so-called Lee method is particular convenient for encoding phase modulation on amplitude-only modulating devices.

FIG. 3A illustrates the steps to be performed by the data processor 210 for determination of the composite hologram which is a discretized composite hologram.

In step 301 a first discretized hologram 311 is determined by determining a first two-dimensional phase distribution σ1(x,y) so that the first discretized hologram generates a desired amplitude profile 151-153 of the pixels 151a-153a in the reconstruction space 111.

Methods for determining the first phase distribution σ1(x,y) comprises the Gerchberg-Saxton algorithm or an analytical approach as referred to above.

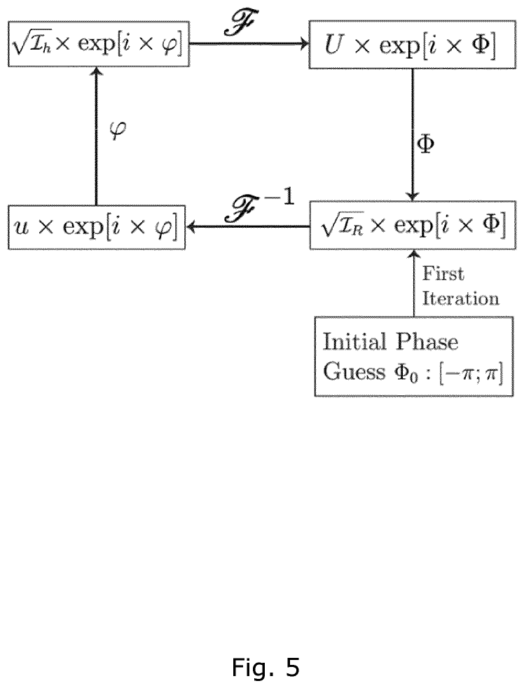

The Gerchberg-Saxton algorithm shown in FIG. 5 takes as input three user-defined variables: the target intensity IR in the reconstruction space 111, the source intensity distribution Ih in the hologram plane 113, and some initial guess ϕ0 for the phase in the reconstruction space 111. The algorithm iteratively propagates a complex field between the hologram and reconstruction space, while constraining the amplitudes in each plane to √Iₕ and √I_{R}, respectively, leaving the phases to be free. The target intensity for the purpose of the shaping of the point spread functions 151-153 is a unity square of side widths ΔXpsf embedded in zeros according to the resolution of the SLM. The exact width of the unity square psf is determined from the equation ΔXpsf≤(N_{T1}×λ×f)/Dslm (see derivation below) and depends on the number of desired tilings of the object hologram, i.e. the second discretized hologram 312. The source amplitude is a Gaussian beam profile, the shape of which is determined using an optical beam profiler. The initial phase guess is a quadratic phase profile with curvature coefficients q and p calculated by q=π/M and P=π/N where M×N is the SLM resolution, i.e. the number of SLM pixels in the X and Y directions.

According to the analytic approach, the lossless shaping of an input Gaussian beam into a flattop beam by use of the phase modulating SLM can be performed by calculating the phase pattern

$$σ1 ( x , y ) = [ β x Φ x ( x ) + β y Φ y ( y ) ]$$

where β is a dimension less number given by

$$β = \frac{\sqrt{2 π} {r}_{0} Δ {x}_{PSF}}{f λ}$$

where ro is the 1/e\hat{ }2 radius of the input Gaussian beam. In addition, ϕx and ϕy are one-dimensional phase functions on the form

$$ϕ ( ξ ) = \frac{\sqrt{π}}{2} ξ erf ( ξ ) + \frac{1}{2} exp ( - {ξ}^{2} ) - \frac{1}{2} \\ where \\ ξ = \frac{\sqrt{2} \cdot x}{{r}_{0}} \\ or \\ ξ = \frac{\sqrt{2} \cdot y}{{r}_{0}}$$

and erf(ξ) is the error function given by

$$erf ( ξ ) = \frac{2}{\sqrt{π}} {\int }_{0}^{ξ} {e}^{- {s}^{2}} ds .$$

In step 302 a second phase distribution σ2(x,y) of a second discretized hologram 312 is determined based on a desired projection, so that the desired projection can be reproduced as a reconstruction image 201 at the reconstruction space 111.

The second phase distribution σ2(x,y) is determined according to known methods of computer generated holography. This can be based on iterative Fourier transform algorithms or lately by using machine learning optimization as demonstrated in this recently published Optics Communications paper: Comparison of state-of-the-art Computer Generated Holography algorithms and a machine learning approach, Optics Communications Volume 505, 15 Feb. 2022, Andreas Erik Gejl Madsen, RenéLynge Eriksen, Jesper Glückstad.

The determination of both first and second phase distributions σ1(x,y), σ2(x,y) are readily extended to 3D in case of a 3D reconstruction space 111.

In step 303, the second discretized hologram 312 is tiled, i.e. repeated, along one or two perpendicular directions in a matrix to generate a discretized tiled hologram 313. The second discretized hologram 312 may be tiled a number of N_{T1} times in the first direction such as the x-direction, i.e. so that second discretized hologram 312 appears N_{T1} times along the first direction. Similarly, the second discretized hologram 312 may be tiled a number of N_{T2} times in a second direction such as the y-direction. In case of a square Spatial Light Modulator (SLM), the hologram may be tiled equally in both directions, i.e. according to N_{T}=N_{T1}=N_{T2}.

In step 304, a discretized composite hologram 314 is determined by phasor multiplying the matrix of the first discretized hologram with the matrix of the tiled second discretized hologram as determined in step 303.

The first discretized hologram 311 can be represented by a matrix M1 of phase values σ1(x,y). The second discretized hologram 312 can be represented by a matrix M2 of phase values σ2(x,y). The tiled hologram 313 is referred to as M2_{T}. Accordingly, the discretized composite hologram 314 is given by the element-for-element phasor product of the two matrices corresponding to the simple addition of respective phase values M_{comp}=M1+M2_{T}.

The phasor multiplication of the matrix of first discretized hologram with the matrix of the tiled second discretized hologram is not an ordinary matrix multiplication but a multiplication where only elements of the same matrix position i,j are multiplied. Accordingly, each element in the composite hologram 314 exp(i·M_{comp}(i,j)) is given according to exp(i·M1(i,j)) multiplied with exp(i·M2_{T}(i,j)) where i denotes \sqrt{−1}. From this it follows that the phase of each element i,j in the composite hologram 314 is given by the sum of phases of the same elements i,j of the first hologram 311 and the tiled hologram 313.

In step 305, the discretized composite hologram 314 is applied to the spatial light modulator SLM to generate the phase modulation of the coherent input beam 101 and the output pixelated projection 201 in the reconstruction space 111.

FIG. 3B illustrates the generation of the pixelated reconstruction image 201 based on the discretized composite hologram 314. The determination of the discretized composite hologram 314 is based on the tiling of the second discretized hologram 312 (object hologram) into a tiled hologram 313 and the phasor multiplication with the first discretized hologram 311. As illustrated, the second discretized hologram 312 is tiled or repeated six times in the x and y directions.

As previously noted, the first and second discretized holograms 311, 312 can be determined so that the pixelated reconstruction image 201 is optimized for a 3D reconstruction space 111. For example, the holograms in this example may be determined for generating the “H” image projection on a curved surface.

In general, the pixelated projection may be a single pixel, i.e. a point projection image, a line of pixels forming a 1D projection image, a surface projection forming a 2D image, or a space or volume projection forming a 3D projection image. Accordingly, the reconstruction space may be a surface or plane in two or three dimensions, i.e. a flat or a curved plane, or the reconstruction space may be a volume, i.e. a space in three dimensions.

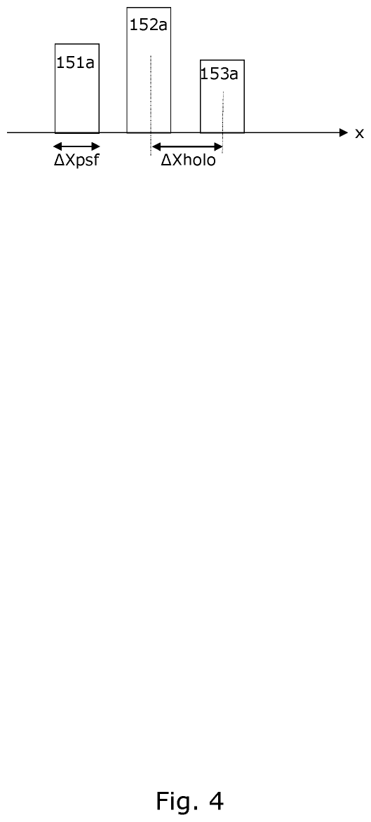

FIG. 4 illustrates output pixels 151a-153a in a pixel row of the pixelated projection 201. The height of the output pixels indicate the pixel amplitude. The output pixels have a width ΔXpsf in the first direction—such as the x-direction—of the pixel row and neighbor output pixels are separated by the distance ΔXholo measured between centers of adjacent pixels. Thus the output pixel pitch in the reconstruction space 111 is given by ΔXholo. The width ΔYpsf and pixel pitch ΔYholo in the perpendicular second direction (not shown) may be equal to or different from the width and separation in the first direction.

To ensure that the pixels 151a-153a do not overlap the first discretized hologram 311 and the tiling numbers NT1, NT2 should be determined so that the output pixel constraint ΔXpsf≤ΔXholo is satisfied in both the first and second direction.

ΔXholo is given according to

$$Δ Xholo = ( NT \times λ \times f ) / ( Dslm )$$

where NT is the number of hologram tiles to be generated on the SLM, and Dslm is the dimension of the pixel area of the SLM here assumed to be square, i.e. to have equal X and Y dimensions

With use of this expression for ΔXholo the output pixel constraint can be formulated as

$$Δ Xpsf \leq Δ Xholo \\ Δ Xpsf \leq ( NT 1 \times λ \times f ) / Dslm \\ NT \geq ( Δ Xpsf \times Dslm ) / ( λ \times f ) ,$$

and similarly for the Y direction although the point spread functions may normally have the same dimensions in both directions. Dslm may be equal for both directions or different for the X and Y directions.

Accordingly, with a predetermined first discretized hologram 311 the pixel width ΔXpsf is fixed and therefore the tiling numbers NT, NT1, NT2 are determined subject to the pixel constraint.

Alternatively, if the tiling numbers NT, NT1, NT2 are predetermined, the pixel width ΔXpsf and therefore, the first discretized hologram 311 must be determined subject to the pixel constraint.

It is also possible that neither the predetermined first discretized hologram 311 nor the tiling numbers NT, NT1, NT2 are predetermined. In that case both the first discretized hologram 311 and the tiling numbers can be determined subject to the pixel constraint, e.g. by use of an iterative calculation process.

The equations above for determining the first and second discretized holograms 311, 312 and the pixel constraint are based on Fourier lens reconstruction. Similar equations for a set-up with a lens-free Fresnel solution can be obtained in a similar way.

The method for generating a pixelated projection in the reconstruction space have multiple uses. Examples include:

Multiphoton excitation. In multiphoton application such as two-photon applications speckle dramatically deteriorates excitations in the reconstruction space due to the intensity squared effect when side lobes of amplitude curves 121-123 generate interference patterns. For example, multiphoton excitation may be used for optical excitation of biological material such as living cells, in vivo or in vitro, e.g. in neurophotonics and optogenetics. Another example, includes 3D stimulation of neurons.

3D printing. The reconstruction image in a 2D or 3D plane can be used for 3D printing of objects. The 3D printing may include photopolymerization, such as two-photon photopolymerization which use the generated reconstruction image. Below a particular embodiment, called volumetric additive manufacturing (VAM), will be explained in more details.
Holographic displaying.
Laser material processing, such as one shot material processing.
Photolithography.
Quantum optics and photonics.
Structured illumination microscopy.
Treatment of skin, such as cosmetic treatment of skin, e.g. for the purpose of tattoo removal.

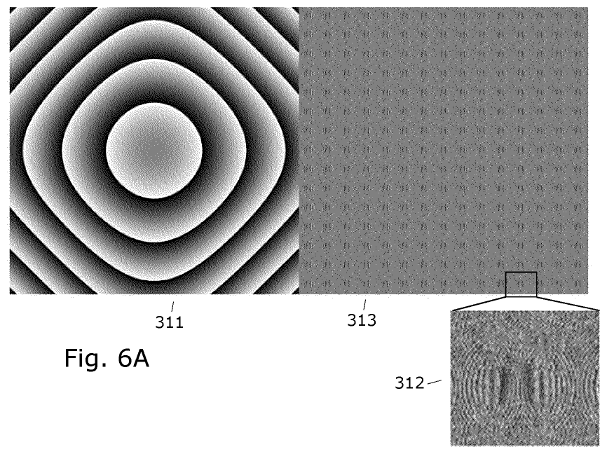

FIG. 6A shows an example of the phase variations of the first discretized hologram 311 and the tiled hologram 313 with an inserted magnified portion corresponding to the second discretized hologram 312.

FIG. 6B shows an example of the pixelated projection 201 and the individual pixels of the image of the projection. The inserted magnified portion shows the individual output pixels.

### HoloTile for Volumetric Additive Manufacturing (VAM)

Tomographic volumetric additive manufacturing (VAM) is a 3D Bioprinting approach where an entire three-dimensional object is simultaneously solidified by irradiating a cell-laden hydrogel from multiple angles with dynamically reconfigured light patterns. Tomographic VAM can in principle bioprint complex centimetre scale organoids in a matter of seconds instead of hours without the need for supporting structures. Typically, a violet light source is applied for the curing. Though tomographic VAM has the potential to produce highly complex structures with a higher throughput and a wider range of printable materials than conventional layer-by-layer additive manufacturing, the resolution is currently limited by the large étendue of the applied illumination systems. Normally, étendue is a property of light in an optical system, which essentially characterizes how much spreading of the light is in area and angle. It corresponds e.g. to the beam parameter product (BPP) in Gaussian beam optics.

Currently, light in-efficient Digital Light Projection of powerful multi-mode sources are applied in tomographic VAM based on simple binary on/off amplitude modulation. By rethinking the whole light addressing for tomographic VAM one can not only circumvent the inherent light in-efficiency and étendue bottlenecks of current bioprinting systems, but also apply real-time aberration correction by using a holographic system or method according to the present invention, in the following called ‘HoloTile’.

The experimentally demonstrated +90% photon efficient phase-only projections of HoloTile inherently solves the challenge of rapid and speckle-free light sculpting for high-fidelity and ultra-fast 3D Bioprinting and works by multiplexing the phase-shaped Point Spread Function (PSF) of the holographic system of the present invention to match the inter spatio-spectral spacing in the far field reconstruction, that occurs due to tiling on a high-resolution phase-only spatial light modulator. Key advantages of this HoloTile light engine include a 100× speed improvement over standard holography, substantial speckle reduction by matched tiling and PSF-shaping, real-time dynamic pixel-discretized projections, lens-free scaling and zoom by software adapted phase-encoding and/or very fast camera-in-the-loop aberration control.

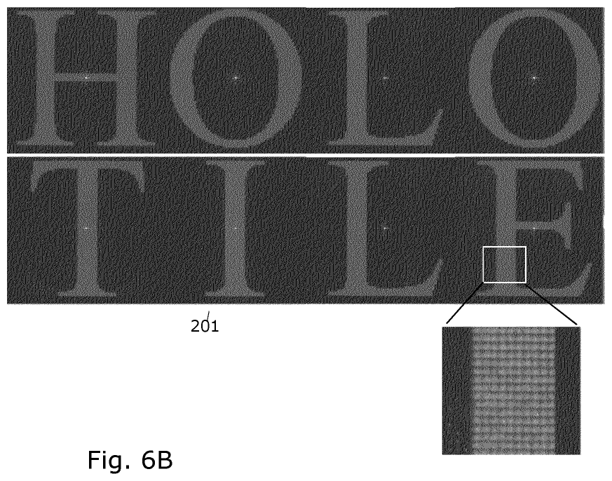

FIG. 7 shows a reconstructing of the SDU-logo by HoloTile on an LCoS spatial light modulator for various output diffraction pattern resolutions.

HoloTile (experimentally shown in FIG. 7 for +90% photon efficient phase-only projected diffraction patterns) aims to solve the challenge of rapid and speckle-free light sculpting without the need for time-averaging techniques—a challenge that exists in several fields of optics, biophotonics, additive manufacturing, display technology and other areas.

HoloTile i.e. a holographic system or method according to the present invention provides rapid and speckle-reduced digital holography and works by multiplexing the phase-shaped Point Spread Function (PSF) of the holographic system to match the inter spatio-spectral spacing in the far field reconstruction, that occurs due to tiling on a high resolution SLM or Diffractive Optical Element (DOE). In particular, HoloTile provides four new unique key features as CGH-modality for high resolution phase-only SLMs, reconfigurable DOEs or new meta-surface/Meta-Optical Element (MOE):
A 100× speed improvement over standard CGH-modalities.
Substantial speckle reduction by matched tiling and PSF-shaping.
Real-time dynamic and output ‘pixel’ discretized digital holograms.
Lens-free scaling or zoom by software adapted HoloTile phase-encoding

Very fast camera-in-the-loop in-situ optimization is made possible by the 100× speed-improvement over standard CGH-modalities and thereby makes HoloTile potentially very attractive for a variety of applications including:
Ultrafast additive manufacturing
Laser material processing in parallel
Rapid laser engraving, welding, machining
Two-photon excitation in optogenetics and voltage imaging
Multi-color and multi-plane diffraction
Photon-efficient phase-only display technology
Real-time adaptive optics embodiments including aberration correction
Temporal Focusing (TF-HoloTile)
Digital quantum holography

In future research and development, it may be possible to demonstrate some of these potential advantages of HoloTile in one or more of the above dynamic or static light diffraction applications. An aim is to use HoloTile as a stand-alone light engine that can be integrated with ease both hardware- and software-wise in existing optics and photonics configurations for both industry and academia.

### HoloTile for Volumetric Bioprinting

Tomographic volumetric additive manufacturing (VAM), is a relatively recent 3D Bioprinting approach where an entire three-dimensional object is simultaneously solidified by irradiating e.g., a cell-laden hydrogel from multiple angles with dynamic light patterns in the violet wavelength regime. Tomographic VAM can print complex centimetre scale objects in a matter of seconds instead of hours without the need for supporting structures. Though tomographic VAM has the potential to produce highly complex structures with a higher throughput and a wider range of printable materials than conventional layer-by-layer additive manufacturing, the resolution is currently limited by the usually large étendue of the applied illumination system. Typically, a so-called Digital Light Projection (DLP) illumination system is applied based on very light in-efficient digital micro-mirror devices operating in binary amplitude mode. For the sparse tomographic projections usually calculated by the Radon transform only a tiny fraction of the total digital micro-mirrors will be deflecting light towards the 3D bioprinting volume and hence a substantial light power source is inherently needed which typically implies a multi-moded large étendue light source.

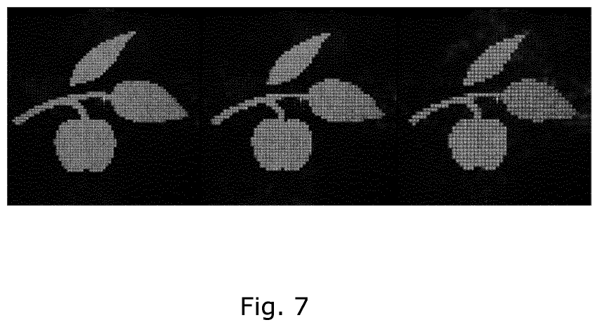

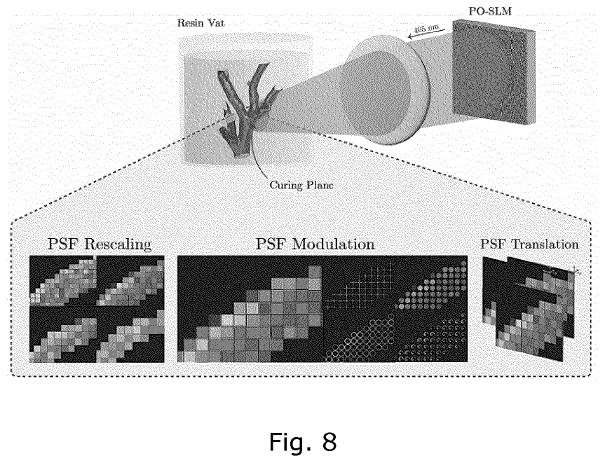

FIG. 8 shows Tomographic VAM system based on a phase-only SLM encoded by HoloTile i.e. a holographic system or method according to the present invention. FIG. 9 shows HoloTile for tomographic and real-time aberration-corrected VAM using a simple camera-in-the-loop approach.

By rethinking the light addressing for tomographic VAM one can circumvent this inherent bottleneck of current 3D Bioprinting system configurations. The below are only some of the inherent advantages that one can get by using the aforementioned HoloTile approach, schematically illustrated in FIGS. 8 and 9:
The phase-only modality of HoloTile provides for a vastly more efficient light modulation engine.
As a derived effect of the much higher light efficiency, a single spatial mode laser diode source can be used having an optimal light étendue and thereby improving the spatial resolution of the 3D Bioprinting.
The spatially coherent HoloTile-projection allows for a 100 times faster refresh rate advantage and unique 3D Point Spread Function (PSF) shaping feature over standard phase-only diffractive optics or computer-generated holography (CGH).
The set of pattern projections in Volume Additive Manufacturing (VAM) can be controlled in a volume by the unique PSF-shaping to produce a higher fidelity 3D bioprinted object.
Less number of optical components required in the HoloTile light projection engine.
The fast refresh rate can provide for real-time aberration-corrected VAM.

Ultimately, it is anticipated that HoloTile holographic system and method can pave the way for highly light efficient VAM of 3D bioprinted centimetre scale objects with optimal étendue and micron-sized features in a few tens of seconds.

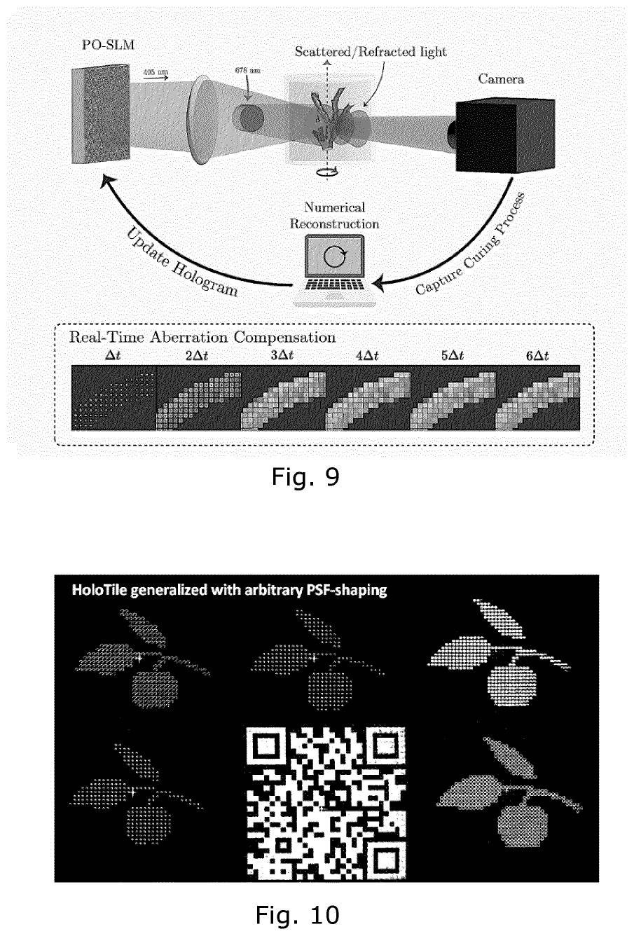

For certain configurations of HoloTile for volumetric addressing it can be advantageous to apply arbitrarily shaped PSF-encodings such as spirals, circles, rings, linear edges, cross hairs etc. Experimental examples of such PSF-shapings are illustrated in FIG. 10.

1. A method for generating a pixelated projection in a reconstruction space comprising:
determining a first discretized hologram having a phase distribution in a plane, wherein the first discretized hologram is determined to generate a desired amplitude profile of an output pixel in the reconstruction space,
determining a second discretized hologram having a phase distribution determined to create a desired projection in the reconstruction space,
determining or generating a tiled hologram by tiling the second discretized hologram a number of one or more times in one or two directions, wherein the number of tilings and the first discretized hologram are determined subject to an output pixel constraint determined based on a dimension (ΔXpsf, ΔYpsf) of the amplitude profile of the output pixel in the reconstruction space and a pixel pitch (ΔXholo, ΔYholo) in the reconstruction space,
determining a composite hologram based on a phasor multiplication of the first discretized hologram and the tiled hologram,
phase modulating a coherent input beam based on the composite hologram and directing the phase modulated beam towards the reconstruction space to generate the pixelated projection in the reconstruction space.

2. The method according to claim 1, wherein the pixel constraint requires that the dimension (ΔXpsf, ΔYpsf) of the amplitude profile of the output pixel is smaller than, equal or substantially equal to the pixel pitch (ΔXholo, ΔYholo).

3. The method according to claim 1 wherein the determination of the tiled hologram comprises determination of a tiling number (NT, NT1, NT2) of the tiled hologram subject to the pixel constraint and the dimension (ΔXpsf, ΔYpsf) of the amplitude profile of the output pixel.

4. The method according to claim 1, wherein the determination of the first discretized hologram comprises determination of the dimension (ΔXpsf, ΔYpsf) of the amplitude profile of the output pixel subject to the pixel constraint and a tiling number (NT, NT1, NT2) of the tiled hologram.

5. The method according to claim 1, wherein the first discretized hologram is determined dependent on a desired dimension (ΔXpsf, ΔYpsf) of the amplitude profile of the output pixel.

6. The method according to claim 5, wherein the first discretized hologram is determined so that at least 70% of a total power of the amplitude profile in the reconstruction space is contained within the output pixel.

7. The method according to claim 1, wherein the determination of the second discretized hologram comprises determining the phase distribution so that at least some of the output pixels of the desired projection are determined to be reconstructed in different positions along a propagation direction of the input beam in the reconstruction space.

8. The method according to claim 1, wherein the phase modulation comprises controlling a spatial light modulator (SLM) to generate a discretized phase distribution corresponding to the first discretized hologram, the tiled hologram or the composite hologram.

9. The method according to claim 1, wherein the reconstruction space is a surface in two or three dimensions or a volume in three dimensions.

10. A holographic system arranged for generating a pixelated projection in a reconstruction space, wherein the holographic system comprises:
a data processor arranged to perform the steps of claim 1,
a light source for generating the coherent input beam, and
a spatial light modulator (SLM) arranged for phase modulating the coherent input beam based on the composite hologram and directing the phase modulated beam towards the reconstruction space to generate the pixelated projection in the reconstruction space.

11. The holographic system according to claim 10, wherein the holographic system comprises a
a first fixed phase mask configured with a discretized phase distribution according to the first discretized hologram and a spatial light modulator arrangement arranged for generating a phase modulation according to the tiled hologram, or
a spatial light modulator (SLM) arranged for generating a phase modulation according to the first discretized hologram and a second fixed phase mask configured with a discretized phase distribution according to the tiled hologram, or
a first fixed phase mask configured with a discretized phase distribution according to the first discretized hologram and a second fixed phase mask configured with a discretized phase distribution according to the tiled hologram, or
a first fixed phase mask configured with a discretized phase distribution according to the composite hologram, and
a light source for generating the coherent input beam and arranged to transmit light through two discretized phase distributions generated by two of the first fixed phase mask, the second fixed phase mask, the spatial light modulator, and the spatial light modulator arrangement or generated by the first fixed phase mask configured with the discretized phase distribution according to the composite hologram and for directing the phase modulated beam towards the reconstruction space to generate the pixelated projection in the reconstruction space.

12. The holographic system according to claim 11, wherein the spatial light modulator arrangement comprises a spatial light modulator and an optical tiling system, wherein the spatial light modulator is arranged to generate the second discretized hologram, alternatively the tiled hologram, and the optical tiling system is arranged to tile the second discretized hologram, alternatively the optical tiling system is arranged to further tile the tiled hologram.

13. The holographic system according to claim 12, wherein the optical tiling system comprises an imaging system, such as a lens array or a mirror scanner, configured to generate the tiling and to project incident light into the reconstruction space.

14. A computer program comprising instructions to cause a data processor to execute the steps of the method of claim 1.

15. Use of the method according to claim 1 for any one of the following:
multiphoton optical excitation of biologic cells,
printing 3D objects,
holographic displaying,
quantum optics and photonics,
photopolymerization, such as two-photon photopolymerization,
laser material processing, such as one shot material processing,
photolithography,
structured illumination microscopy,
treatment of skin, such as cosmetic treatment of skin,
in conjunction with temporal focusing of an ultrafast pulsed laser for multiphoton excitation in selected depth layers,
ultrafast additive manufacturing,
laser material processing in parallel,
rapid laser engraving, welding, machining
two-photon excitation in optogenetics and voltage imaging
multi-color and multi-plane diffraction
photon-efficient phase-only display technology
real-time adaptive optics embodiments including aberration correction, and
temporal focusing (TF).

16. Use of the method according to claim 1, for printing 3D objects using volumetric additive manufacturing (VAM), preferably for printing 3D objects for medical use, preferably biocompatible implants, synthetic organs, or parts thereof, or similar objects.
